(19) United States
(12) Patent Application Publication
(10) Pub. No.: US 2008/0004954 A1
(43) Pub. Date: Jan. 3, 2008

(54) METHODS AND ARCHITECTURE FOR PERFORMING CLIENT-SIDE DIRECTED MARKETING WITH CACHING AND LOCAL ANALYTICS FOR ENHANCED PRIVACY AND MINIMAL DISRUPTION

(75) Inventor: Eric J. Horvitz, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/428,224

(22) Filed: Jun. 30, 2006

(51) Int. Cl. G06Q 30/00

(52) U.S. Cl. 705/14

(57) ABSTRACT

Methods and architectures are disclosed for performing directed marketing in client applications. Operating systems and applications such as computer games, word processors, etc., are used as vehicles for presentation of advertisements. Techniques are included that maximize the effectiveness of impressions while maintaining privacy and minimizing disruption by performing local analysis of content and behavior. Local analysis can consider useful details of personal content and activities, yet this information is kept private, on the user's machine. The information is used by local learning, reasoning, and matching methods to select impressions from spanning advertising content cached on the local machine. Signals about usage or activity can be returned with user confirmation and used to design future advertisement caches sent as updates.

### BACKGROUND

The Internet provides unprecedented access to an ever-increasing number of potential customers ranging from businesses to individuals. For example, Internet-gaming such as casino-type games and computer games have skyrocketed to a multi-billion dollar industry, thereby providing a form of leisure activity for millions of users while also providing a boon to companies involved in such an industry by providing access to new sources of advertising revenue. Money expended for online advertising in the United States alone, is in the billions of dollars per year, and continues to increase with no end in sight. Additionally, rapid advances in cellular networks and related products have followed suit making cell phones and cell-capable devices just as pervasive as IP-based devices, if not more pervasive, than such computing devices providing access to yet even more people and sources of advertising revenue.

At a high level, conventional advertising techniques use mass media (e.g., television and radio) and heavily traveled areas such as major highways as principal means for reaching large numbers of viewers and listeners with the hope that he or she will see the advertisement (e.g., in the form of billboards or television commercials) and make a purchase. However, such techniques are limited, since the advertisement has to be created to reach a broad spectrum of potential customers. A better solution would be to reach more individuals at a lower level, such as the capability of going “one-on-one” with each potential customer and to target each individual based on his or her preferences, tastes, buying habits, wants, needs, and so on, to offer the most effect means for making a sale. In view of such lucrative opportunities, businesses continue to search for new and more effective mechanisms for advertising.

### SUMMARY

The following presents a simplified summary in order to provide a basic understanding of some aspects of the disclosed innovation. This summary is not an extensive overview, and it is not intended to identify key/critical elements or to delineate the scope thereof Its sole purpose is to present some concepts in a simplified form as a prelude to the more detailed description that is presented later.

The disclosed architecture facilitates a means of reaching populations of potential customers by employing advertising in client applications. For example, computer games (e.g., solitaire and racing games) and other client applications such as word processors, e-mail programs, operating systems, development tools, and the like, can now be used as vehicles for the presentation of advertisements. Screen real estate is used to display real advertisements. For example, the back of cards in a solitaire game can be used as ad space. In a computer-based racing game, billboard space along a virtual race track can display real ads paid for by an advertising vendor. In yet other implementations, advertisements can be inserted into the programming applications and development tools for presentation to an individual.

Under the general context of client-side advertising, the disclosed architecture also considers user information such as personal content, activities, and behavioral information that can be captured and utilized, and privacy issues associated with this type of information. For example, in one implementation, privacy is managed by the user controlling when user information is to be communicated to a remote location. This can be handled directly through prompts or automatically based on user preferences or other settings, for example.

Local analysis (e.g., probabilistic and/or decision-theoretic models) can be employed to derive probabilities and, to learn and reason in support of client-side processing related to many different aspects, such as timing related to the local caching and/or presentation of content, user attention, interest enhancing techniques, monitoring clickthrough information (e.g., for content feedback), and minimizing disruption (e.g., based on completion of a task, application transitioning) to the user if, for example, the user is engaged in contexts or environments that involve safety (e.g., operating a vehicle), with which the user desires not to be interrupted (e.g., drafting documents, meetings . . . ), and so on. Such models can also be utilized to maintain privacy while taking advantage of local information, via processing the user information within the bounds of a user's system.

The model(s) can also be employed to develop function(s) related to minimizing user frustration in client-side processes (e.g., ad content, ad type, application launch times, . . . ) which can be learned and reasoned about based on application and/or system process transitions, and close or shutdown times and process, for example.

Accordingly, disclosed and claimed herein, in one aspect thereof, is a computer-implemented system that facilitates advertising in a client application. An advertisement component is provided for receiving and processing advertisement content or data. An application component facilitates insertion of the advertisement content into a client application for presentation to a user. The advertisement content can be in the form of at least one of text, graphics, an image, audio data, and video data. A conversion component converts the advertisement content for presentation in the client application. The advertisement component receives a pack of advertisements (or an “ad pack”) that includes one or more advertisements each of which can have a place of insertion and presentation in the client application.

In another aspect of the subject invention, a user component provides user state information, the processing of which determines which advertisement content is inserted into the client application for presentation.

In yet another aspect, the advertisement content is inserted into a client-based game (or gaming) application such that the advertisement content appears in the virtual gaming environment for perception by a user.

In still another aspect thereof, a logging component is provided for logging user interaction with the client application. The user interaction data is then processed to determine where the advertisement content is displayed in the client application.

Yet another aspect caches in the client computer advertisements and/or other types of content that are selectively displayed or processed based on user state and/or preferences and system resources.

In yet another aspect thereof, a machine learning and reasoning component is provided that employs a probabilistic and/or statistical-based analysis to prognose or infer an action that a user desires to be automatically performed.

Additional novel aspects described herein relate to model building and, prediction and matching on the client-side by downloading/caching spanning content for advertising that provides enough fodder so as to do locally, personalized, and context-sensitive matching based on analysis (locally and privately) of a user's content (documents) and behavior (e.g., application usage, searching, locations, patterns of locations with GPS), and even derived demographics (e.g., look in particular locations and at behaviors to infer a probability distribution over age, gender, . . . ).

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system that facilitates client-side advertising in a client application, in accordance with a novel aspect of the subject innovation.

FIG. 2 illustrates a methodology of client-side application advertising in accordance with an innovative aspect.

FIG. 3 illustrates a system where the advertisement component includes advertisement packs (or “ad packs”) for different application usage, in accordance with another aspect.

FIG. 4 illustrates a methodology of processing advertisements for application insertion in accordance with another aspect of the innovation.

FIG. 5 illustrates a more detailed block diagram of one implementation of the application component.

FIG. 6 illustrates a flow block diagram of extracting and inserting ads into scenes of an application environment accordance with the disclosed innovation.

FIG. 7 illustrates a flow diagram of a methodology of advertisement exchange between an ad server and the client.

FIG. 8 illustrates a methodology updating ads for client application insertion processing.

FIG. 9 illustrates a methodology of logging advertisement information for accounting purposes in accordance with an aspect.

FIG. 10 illustrates a flow diagram of a methodology of ad processing for a client gaming application.

FIG. 11 illustrates a flow diagram of a methodology of ad processing for a development tools application.

FIG. 12 illustrates shows a perspective screenshot of a scene in game application that displays advertisements.

FIG. 13 illustrates a screenshot of a client browser application in which a personalized advertisement is placed for presentation to a client user.

FIG. 14 illustrates a system that employs a machine learning and reasoning component in support of client-side advertising.

FIG. 15 illustrates a methodology of inserting person information into an advertisement for presentation within a client application environment.

FIG. 16 illustrates an exemplary system for geocentric caching and rendering of content.

FIG. 17 illustrates a methodology of managing client-side information based on privacy.

FIG. 18 illustrates a methodology of managing client-side information related to the timing of processes.

FIG. 19 illustrates a methodology of managing client-side disruptions of user and/or client processes.

FIG. 20 illustrates a methodology of enhancing user interest in client-side processes or information.

FIG. 21 illustrates a block diagram of a computer operable to execute the disclosed client-side application advertisement processing and insertion architecture.

FIG. 22 illustrates a schematic block diagram of an exemplary client application advertisement processing and insertion computing environment in accordance with another aspect.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The disclosed architecture facilitates client-side advertising in client applications. Computer and/or device games (e.g., solitaire, racing games, . . . ) can make use of screen real estate to display real advertisements (also called “ads”). For example, in the computer game of solitaire the back of cards can be used as advertisement space. In another example of a racing game, billboard space along the virtual race track can be utilized to display real ads paid for by an advertising vendor (e.g., the manufacturer of the computer on which the game is being played). Other implementations include coupling ad services to application development tools, for example. Virtually any application can be utilized for ad space. In yet another implementation, the client computer is used to cache large amounts of the ads, and which thereafter can be selectively displayed based on user state during the game play and/or user preferences setup in the application.

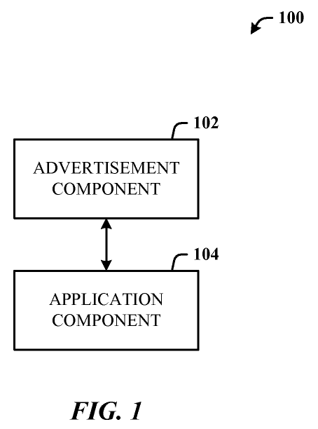

Referring initially to the drawings, FIG. 1 illustrates a computer-implemented system 100 that facilitates client-side advertising in a client application, in accordance with a novel aspect of the subject innovation. An advertisement component 102 is provided for receiving and processing advertisement content. The system 100 also includes an application component 104 for inserting the advertisement content into a client application for presentation to a user.

The advertisement content (or data) can be inserted using many different format types, for example, in the form of text, graphics, images, audio data, video data, and short animated clips. As will be described in greater detail herein, the type of format and content can also be determined based on user preferences and/or the state of the user while in the application. For example, if the user is playing a computer game and is well behind in the scoring, an ad can automatically and dynamically be inserted into the playing environment (e.g., on a wall of a virtual building) that directs the player to another website where other players whose skills are more inline with the user's skills play the game.

Additionally, the ad content can be automatically formatted for the space into which it can be designated for display. Furthermore, based on the type of application, the ad content, ad format, and the expected duration that the user viewer will most likely have to view the ad content, this can all be factored in to determine which ad to insert, whether it should be in text only, etc. For example, if the application is an application development tool where it is expected that the user viewer will dwell on a page for some time, the format of the ad can be a short video clip (e.g., seconds in duration). On the other hand, if the user is playing a computer game, it could be expected that the dwell time at any game scene could be short. Accordingly, the ad context could be presented in text, which normally takes a very short time to process for presentation, in contrast to a video clip or an audio file.

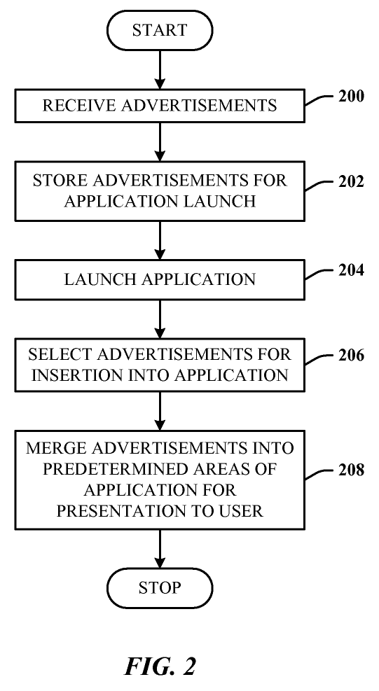

FIG. 2 illustrates a methodology of client-side application advertising in accordance with an innovative aspect. While, for purposes of simplicity of explanation, the one or more methodologies shown herein, for example, in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 200, advertisements are received for insertion processing. At 202, the advertisements are stored for application launch. Note that the advertisements can be stored on a network ad server and/or the client machine (or device) for access. At 204, the client application is launched. At 206, advertisements are selected based on the application launched, and for insertion therein. At 208, the advertisements are merged into the application at predetermined areas for presentation to the user.

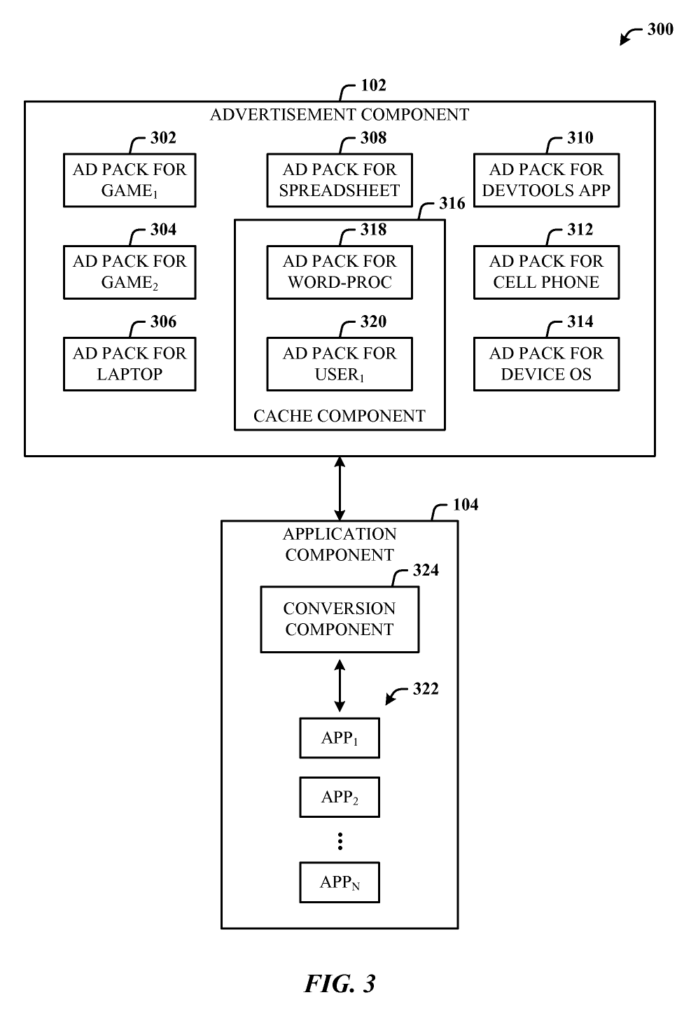

FIG. 3 illustrates a client system 300 where the advertisement component 102 includes advertisement packs (or “ad packs”) for different application usage, in accordance with another aspect. An ad pack can be a bundled set of advertisements for a specific purpose, or a single advertisement. For example, a first ad pack 302 can be assembled for a first computer game. It would be known by the game manufacturer all of the various places in which an ad could be inserted, the size and type of ad that can be inserted, and so on. Accordingly, ad packs can be assembled in content, format, size, and location for each game application. Furthermore, such ads can be customized to the game player. It is to be understood that an ad pack can contain only a single ad for use. Moreover, the same single ad can be formatted in several different ways (e.g., text and audio) for insertion in several different places in the single application.

In this particular implementation, several difference types of ad packs can be assembled and provided. The first ad pack 302 is assembled and configured for a first game application (GAME₁), a second ad pack 304 is for a second game application (GAME₂), a third ad pack 306 is for a laptop computer. The third ad pack 306 can include ads for several different applications (e.g. browser, word processor, and game) run on the laptop computer. Accordingly, this ad pack can be a default set of ads that are distributed to or bundled with the laptop when the computer was sold. A fourth ad pack 308 can be assembled and configured to a spreadsheet application, a fifth ad pack 310 can be provided for a development tools application (DEVTOOLS), a sixth ad pack 312 can be provided for a cell phone client (where the advertisement component 102 is on the cell phone), and another ad pack 314 provided for an operating system (OS).

The advertisement component 102 can be hosted on a network server and/or the client system. In any case, a cache component 316 can be provided for caching one or more ad packs for quick access and processing and/or separate ads for faster processing. The cache component 316 can cache an ad pack 318 for a word processing application (WORD-PROC), and a user-based ad pack 320 for a user (USER,). The user-based ad pack 320 can be configured by a single vendor, or multiple ads from different vendors.

The application component 104 can include one or more different applications 322 (APP₁,APP₂, . . . , APP_{N}, where N is an integer) for ad insertion. In support thereof, a conversion component 324 is provided for converting the ad packs for use in the respective applications 322. Converting can include a process of extracting an ad from an ad pack, for example.

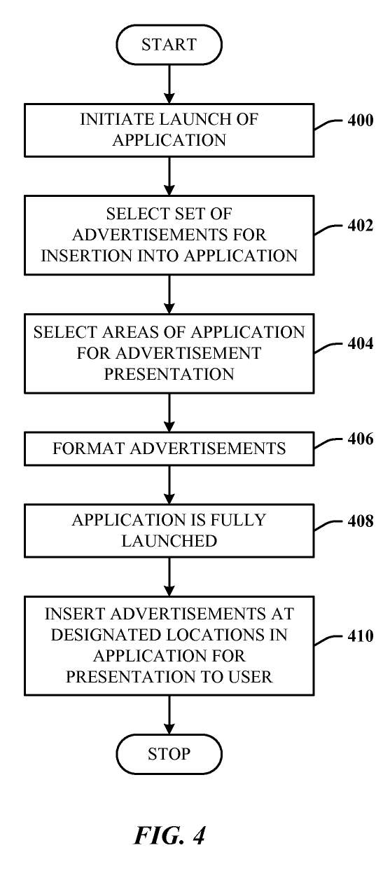

FIG. 4 illustrates a methodology of processing advertisements for application insertion in accordance with another aspect of the innovation. At 400, the user initiates application launch. At 402, a set (or pack) of advertisements is selected for insertion. At 404, areas or places in the application are selected for ad insertion. At 406, once the places are selected, all or select ones of the ads are formatted for the specific place to which each will be inserted. For example, given three different places in the application for ad placement, a first place can be more suited for a text-based ad, a second place can be more suited for an image-based ad, and the third place can be more suited for a short video clip. As indicated supra, the ad pack can have only a single ad; however, the ad can be provided in three different formats—text, a single image and a short video clip. The ads can come “pre-fitted” for placement, since this is known beforehand, or the ads can still require some reformatting before placement. For example, the image ad can be reduced in pixel size from 300×200 to 150×100 pixels.

At 408, the application completes its launching process, and is now fully launched. At 410, the ads, formatted and otherwise, can now be inserted into the application for presentation. In one implementation, this insertion process occurs as the page is being presented for viewing. In another implementation, insertion can occur transparently and in the background after the application has fully launched, but before the user opens a page or screen in which the ad is to be viewed.

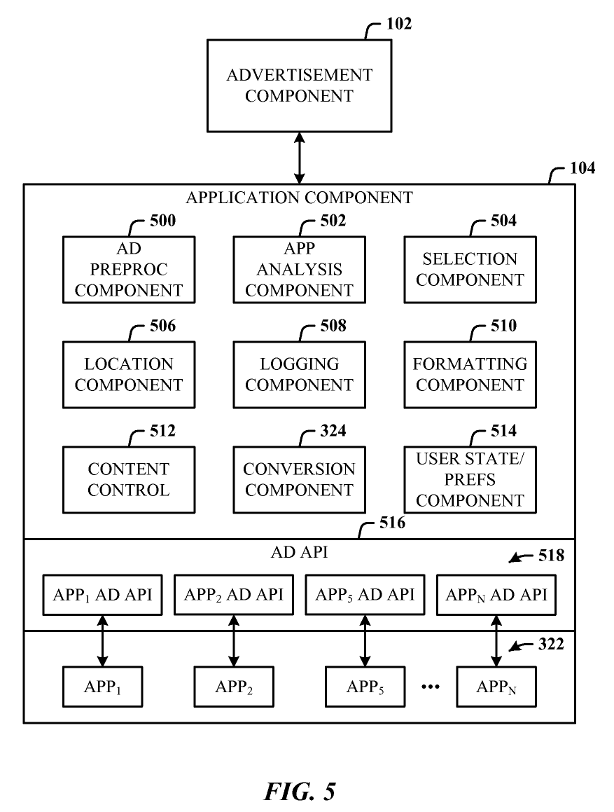

FIG. 5 illustrates a more detailed block diagram of one implementation of the application component 104 on a client system. When an ad pack is accessed for insertion, a number of different processes can be performed. The application component 104 can include an ad preprocessing component 500 that receives the ad pack into the application component 104 from the advertisement component 102. An application analysis component 502 can analyze the client application for places of ad insertion. As described supra, this can be predetermined by the application vendor, or be determined locally at the client by the analysis component 502. A selection component 504 facilitates selecting one or more ad packs and/or client applications for processing.

A location component 506 facilitates location determination for ad placement in a given application. A logging component 508 logs several different parameters associated with ad presentation, for example, content, ad size, data file size, duration of viewing, and so on, for accounting purposes. The logged ad information can be batch processed and uploaded to an ad server for accounting purposes. A formatting component 510 processes each ad of the ad pack that will be inserted into the client application. In some cases, no formatting is required. A content control component 512 facilitates control over what content can be inserted for presentation in the client application. For example, if the user has not registered the application, user control over content advertising in the application can be more limited. However, if the user has registered the application, the user can be given more control over what content can be shown. In some cases, the user will be allowed to turn off any advertising content in the application. In another example, the user is allowed to turn off video clips, which can take additional client system processing to execute, but cannot turn off ad images or text.

A user state and/or user preferences component 514 facilitates consideration of the state of the user during, for example, a gaming application, or where the user may be in a development application. For example, if the user is engaged in a gaming application, such as a first-person shooter (FPS) action game, user progress can be gauged by points and levels of play that require more skill. The game vendor can have inserted into game features, advertisements that inform the user of other similar FPS vendor games that are soon to be arriving in stores. In another example, hints at how to improve skills or to maneuver through the level can be posted on a building wall in the form of an advertisement sponsored by the vendor, or another commercial entity that pays for the spot.

With respect to user preferences, a client application can prompt the user during installation about certain aspects or features the user would prefer or not prefer to view or to have activated in the application. Accordingly, ads can be inserted and controlled based on these user preferences. For example, if based on user preferences, the user prefers to daily see sports information related to soccer while working in a programming application, such information can be inserted into the application for viewing on each page or screen that the user views. This can also be controlled by the content component 512 to be shown at predetermined times (e.g., at 9 AM, noon, and/or 3 PM), in any application that the user currently has launched, and additionally, in the foreground.

The conversion component 324 facilitates conversion of information to an ad API (application program interface) 516. The ad API 516 facilitates access to a plurality of different applications via one or more application ad APIs 518 (denoted APP₁ AD API, APP₂ AD API, . . . , APP_{N} AD API, where N is an integer). Thus, the application component 104 facilitates ad processing and insertion into a plurality 322 of client-side applications.

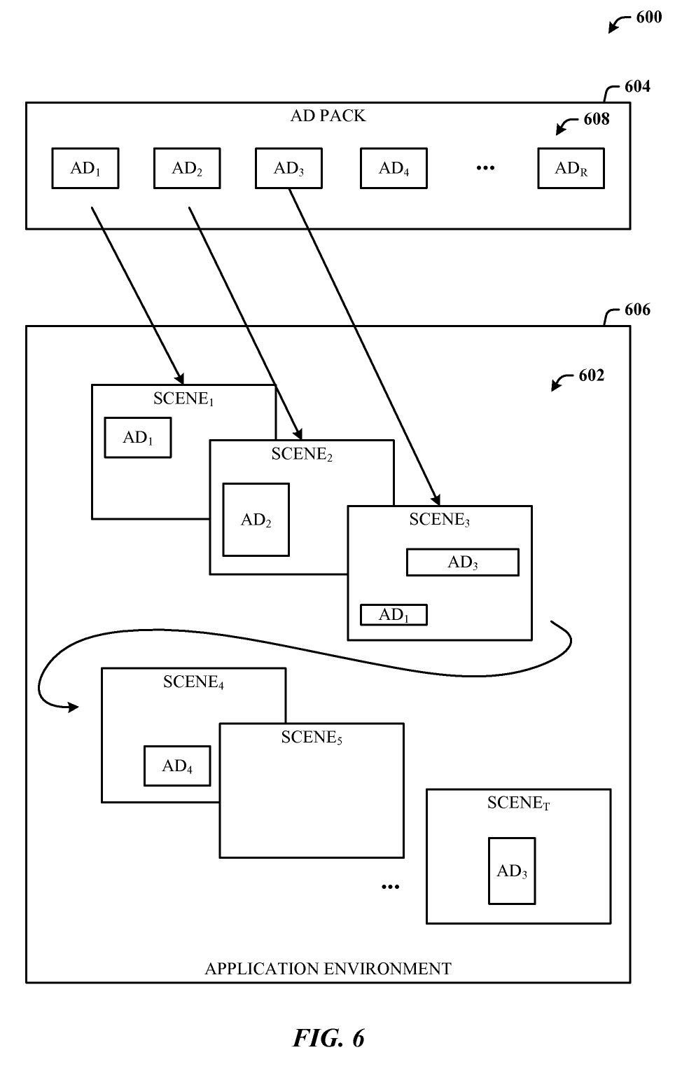

Referring now to FIG. 6, there is illustrated a flow block diagram 600 of extracting and inserting ads into scenes 602 of an application environment accordance with the disclosed innovation. An ad pack 604 has been selected for insertion processing into an application environment 606. As illustrated, the ad pack 604 can include just one ad or many ads (denoted AD₁, AD₂, AD₃, AD₄, . . . , AD_{R}, where R is an integer). Similarly, the application environment 606 can include many different scenes 602 (denoted SCENE₁, SCENE₂, SCENE₃, SCENE₄, . . . , SCENE_{T}, where T is an integer) that can include as insertion and placement. Here, a first ad (AD₁) of the ad pack 604 is processed for insertion into a first scene (SCENE₁), a second ad (AD₂) is processed for insertion and placement in a second scene (SCENE₂), a third scene (SCENE₃) receives two ads-the first ad (AD₁) and the third ad (AD₃), a fourth scene (SCENE₄) receives a fourth ad (AD₄) from the ad pack 604, a fifth scene (SCENE₅) does not include any ads, and the T^{th} scene (SCENE_{T}) includes the third ad (AD₃).

Note also that due to formatting for placement in the particular scene, the size and shape of the ad can be changed. For example, the first ad (AD₁) in the first scene (SCENE₁) has dimensions that are different than for the same first ad as inserted into the third scene (SCENE₃). Similarly, the dimensions of the third ad (AD₃) as inserted into the third scene (SCENE₃) are different than the same ad as inserted into the T^{th} scene (SCENE_{T}).

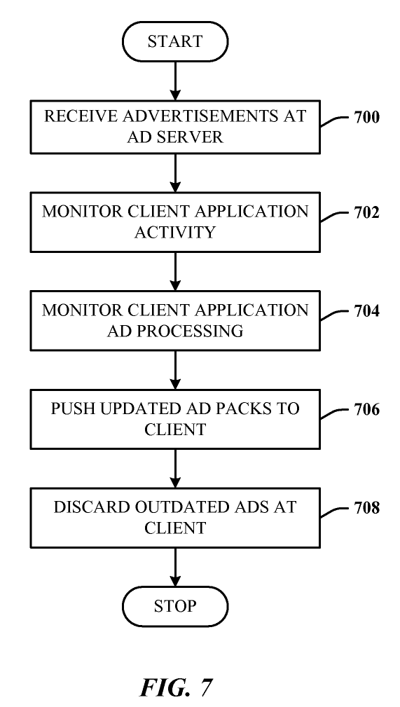

FIG. 7 illustrates a flow diagram of a methodology of advertisement exchange between an ad server and the client. At 700, ads are received at an ad server. These ads can be received from a subscribed vendor for placement into subscribed applications. Accordingly, accounting can be handled at this level, based on the ad characteristics (e.g., size, content, format, type, number of ads, . . . ) and the number of licensed client applications. At 702, client application activity can be monitored (e.g. by the use of cookies). At 704, client application ad processing can be monitored. For example, it is to be understood that in some implementations, the user can disable an ad. This activity can be monitored, such that based on user response, a new ad can be inserted for presentation, as indicated at 706, by pushing a new ad pack to the client for insertion processing. At 708, the outdated ads can then be either discarded at the client, or stored at the client for later access.

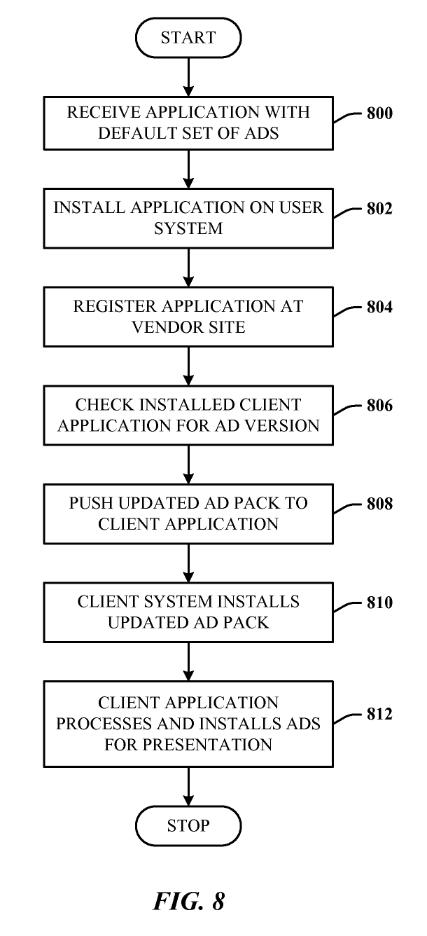

FIG. 8 illustrates a methodology updating ads for client application insertion processing. At 800, an application is purchased by a user with a default set of ads for presentation. These ads can be placed solely for the vendor's own products and/or for other businesses aligned with the vendor. At 802, the user installs the application. Note that the application can come pre-installed on a purchased computing system or be installed after purchase. At 804, the user registers the application with a vendor registration server. At 806, the vendor registration server accesses the installed client application for ad version information. At 808, if the ad version is sufficiently outdated, the server pushes an updated ad pack to the client system. At 810, the client system automatically installs the updated ad pack into the client application. At 812, the updated ads are processed and presented for user viewing.

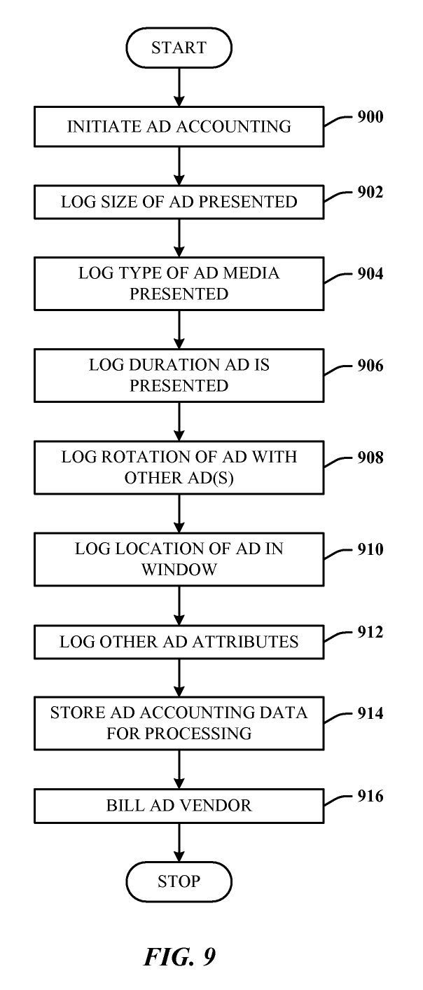

FIG. 9 illustrates a methodology of logging advertisement information for accounting purposes in accordance with an aspect. At 900, ad accounting in initiated. This can occur automatically as a background process when an application is launched. Moreover, it is to be appreciated that a single accounting algorithm can be employed for all client applications, or separate accounting algorithms for each client application launched. At 902, the ad size (e.g., in bytes and pixel size) can be logged. An ad larger in pixel size can be charged out for more money than a smaller ad. Additionally, an ad that requires more processing power for presentation (e.g. an image) can be charged out for more money than one that takes less CPU power (e.g. text). At 904, the type of ad media can be logged. For example, a short video clip can have more appeal to a viewer, and hence, more value than a still image, where the viewer appeal can be measured by the time spent in presentation. However, if it is logged that once the video clip is initiated, the user terminates or navigates away from the presentation process, it can be inferred that for that particular user, the value of the video clip can be reduced.

At 906, the accounting process can also include logging the amount of time that the ad was presented. The longer that the ad is presented, the more revenue received. At 908, in more robust implementations, several ads can be rotated through a single ad space in the application. This rotation information can also be logged as a chargeable cost to the ad vendor. At 910, the location of the ad also has value, and can be considered. For example, an ad placed closer to the center of the scene, page, document, etc., can have more value than an ad placed in a corner. At 912, other ad attributes can also be logged. For example, cost can be based on ad content, and be based on current events. For example, an ad for a new car can be timed for presentation at a time when the new car is being first offered for sale. Based on the time at which the ad was presented in proximity to the current event, it can cost more or less (more, if closer, and less, if not as close). Additionally, ad space can be auctioned off at any moment in time, wherein the winner of the auction can have its ad dynamically inserted into the client application for presentation. At 914, the ad accounting information can be logged locally at the client system, and uploaded at a later time, or uploaded automatically, as the user interacts with the client application. Once the logged information is received at the ad server, it can be further processed for billing the vendor or ad owner, as indicated at 916.

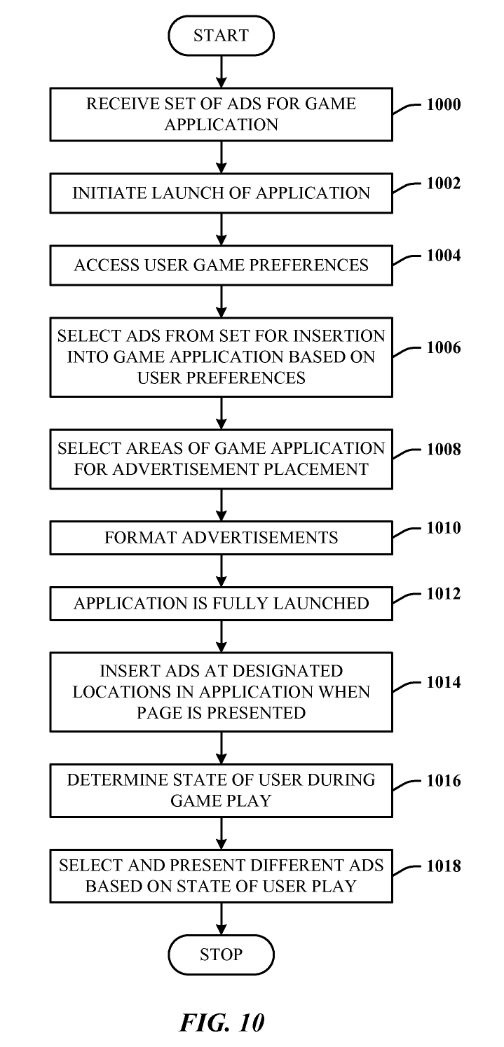

FIG. 10 illustrates a flow diagram of a methodology of ad processing for a client gaming application. At 1000, a set of ads is received for the game application. At 1002, the user initiates launch of the application. It is also to be understood that the user can configure the application to be launched automatically by the computer or device OS. At 1004, user game preferences are accessed. At 1006, ads are selected from the ad pack for insertion into the game application based on the user preferences. At 1008, areas of placement in the game application are selected. At 1010, the ads are formatted to fit the selected areas. At 1012, the application is fully launched. At 1014, the ads are automatically inserted into the designated areas when the page is presented. It is to be appreciated that ad insertion can be done as a background process as the user works within another application. Thus, when the user launches the game application, the ads are already in place and operational (in the example of video clips). At 1016, the state of the user during game play is determined. At 1018, different ads can be selected and inserted based on the user's game play.

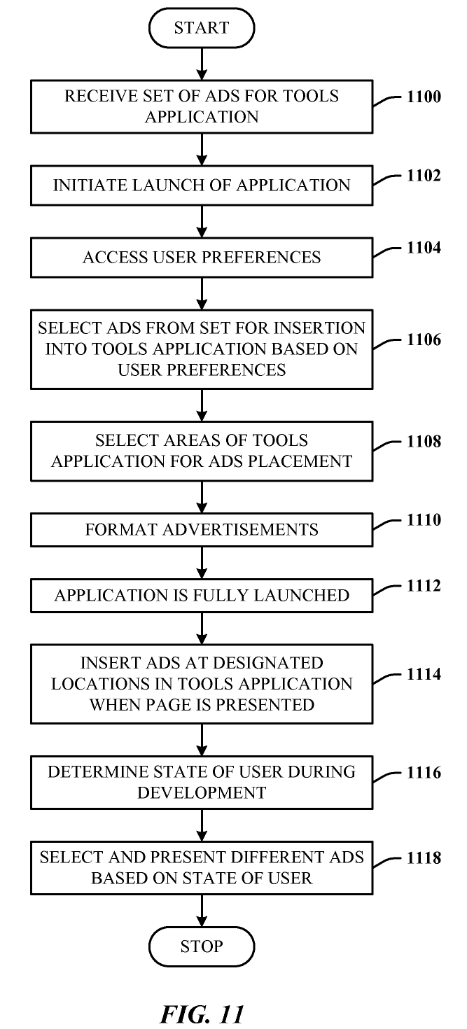

FIG. 11 illustrates a flow diagram of a methodology of ad processing for a development tools application. At 1100, a set of ads is received for the application. At 1102, the user initiates launch of the application. It is also to be understood that the user can configure the application to be launched automatically by the computer or device OS. At 1 104, user preferences are accessed. At 1106, ads are selected from the ad pack for insertion into the tools application based on the user preferences. At 1 108, areas of placement in the tools application are selected. At 1110, the ads are formatted to fit the selected areas. At 11 12, the application is fully launched. At 1114, the ads are automatically inserted into the designated areas when the page is presented. It is to be appreciated that ad insertion can be done as a background process as the user works within another application. Thus, when the user launches the tools application, the ads are already in place and operational (in the example of video clips). At 1116, the state of the user during application development is determined. At 1118, different ads can be selected and inserted based on the user's state in the tools application.

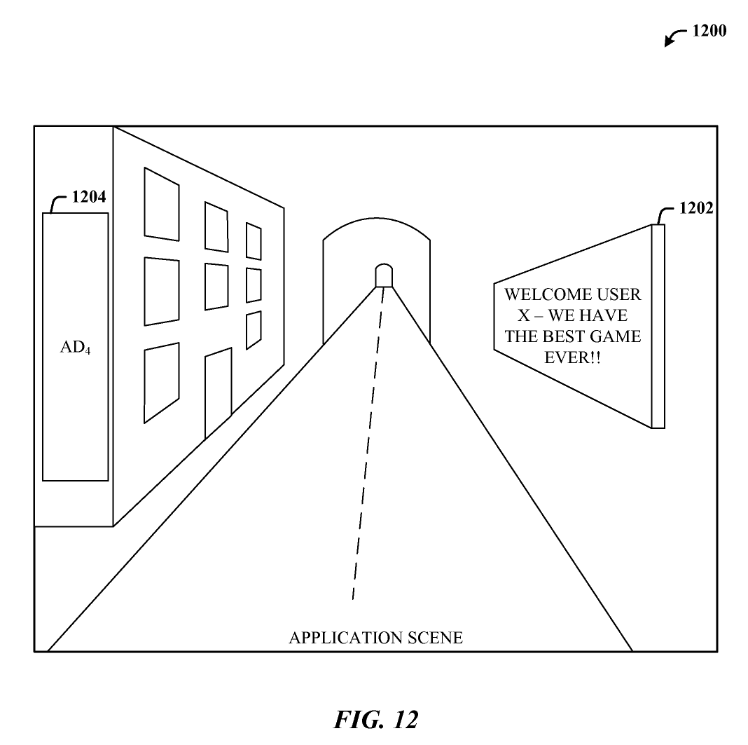

FIG. 12 shows a perspective screenshot of a scene 1200 in game application that displays advertisements. Here, two ads are presented. A first ad 1202 is displayed in a graphical representation of a billboard along a street or highway. A second ad 1204 (AD₄) is inserted into a graphical representation of the side of a building past which the user will navigate as he or she moves down the road (or through the scene 1200).

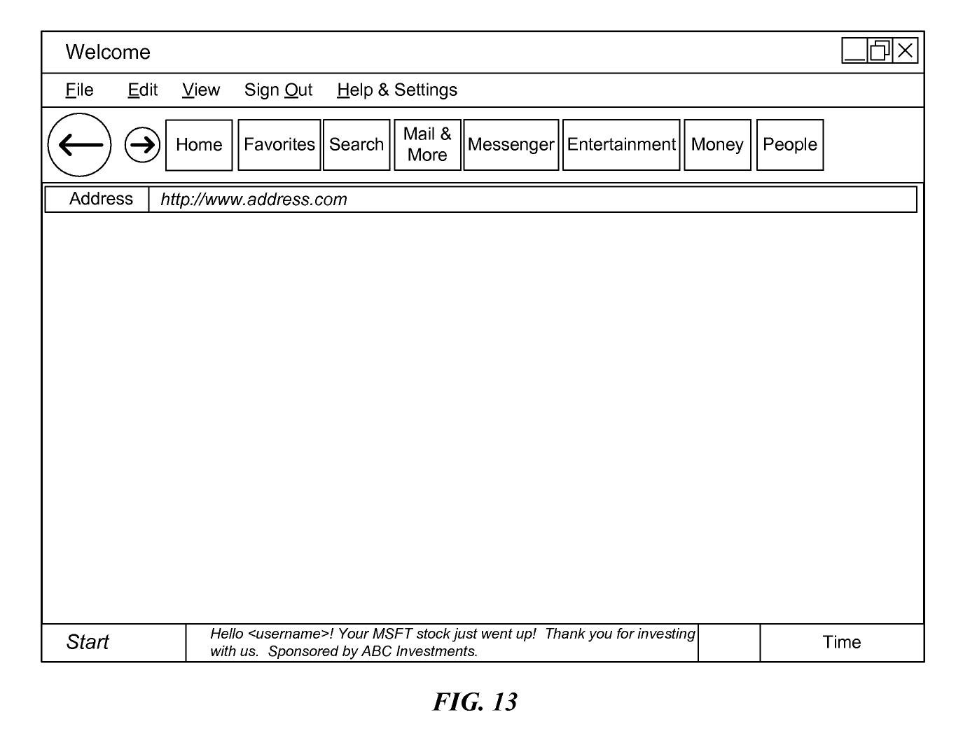

FIG. 13 illustrates a screenshot 1300 of a client browser application in which a personalized advertisement 1302 is placed for presentation to a client user. Here, the username is inserted into a portion of the browser page, and sponsored by an investment company that the user employs for his or her stock.

While certain ways of displaying information to users are shown and described with respect to certain figures as screenshots, those skilled in the relevant art will recognize that various other alternatives can be employed. The terms “screen,” “screenshot”, “webpage,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

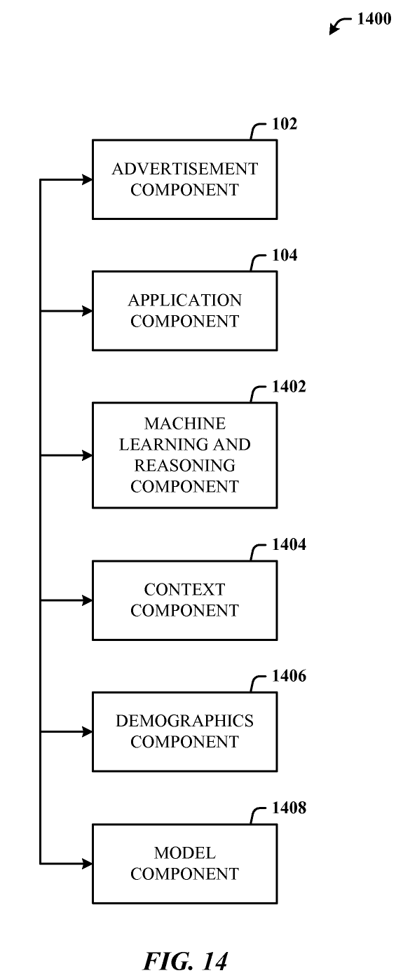

FIG. 14 illustrates a system 1400 that employs a machine learning and reasoning (MLR) component 1402 which facilitates automating one or more features associated with the advertisement component 102 and the application component 104, in accordance with the subject innovation. Additionally, a context component 1404 can be provided to sense, collect and store context information related to the client's geographic location and patterns of locations using, for example, GPS or terrestrial-based geolocation systems. A demographics component 1406 can be employed to collect analyze and process demographic information, to look in particular locations and at behaviors, and in combination with the MLR component 1402, infer a probability distribution over age, gender, etc. A model component 1408 can be utilized to develop and execute models related demographics, context, privacy, timing, caching, user and system disruptions and user frustrations, user and system behavior, and data manipulations, for example. All or portions of the system 1400 can be included in the client-side system for local analysis and processing.

The subject invention (e.g., in connection with selection) can employ various MLR-based schemes for carrying out various aspects thereof. For example, a process for determining where to insert an advertisement can be facilitated via an automatic classifier system and process.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or other statistical analysis (e.g., one factoring into the analysis utilities and costs to maximize the expected value to one or more people) to prognose or infer an action that a user desires to be automatically performed.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of ranking or priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be employed to automatically learn and perform a number of functions according to predetermined criteria.

In another implementation, the MLR component 1402 can be employed to learn from and reason about user interaction with an application and therefrom, replace an existing advertisement with another, while the user is in the application, to provide a more focused presentation of product content to the user. For example, if the user is working in an application development tool, an ad presented in one window can be related to a new tool plug-in soon to be released. However, based on current user interaction where it may be inferred that the user may be struggling with the programming, the plug-in ad can be replaced with an new ad that suggests a work-around tool of a third-party vendor until the plug-in is released.

In an online computer game environment, the MLR component 1402 can learn and reason that in a specific scene, the user tends to not perform as well as competing players and/or robots (computer-generated and controlled players). Accordingly, an ad can be inserted in the scene that, rather than touting a new vendor game release, can be replaced with an ad that makes a suggestion to the user on how to improve his or her skill in that scene, and further comprising ad sponsorship information, for example, “This helper sponsored by Vendor X”. This ad would not be perceived by other online gamers, but is specific to only the user. In fact, the other online gamers could see a similar ad, the same ad, a totally different ad, or none at all.

Similar learning and reasoning can be employed for dynamic ad processing and presentation for targeting a user of a casino gaming client application, for example, whether an online multiplayer version, or a single player version. Ad packs can be pushed to the client computer, and thereafter customized for the specific user at the client. That is, the ad packs can come with advertisements having hooks for inserting a user name into the ad for addressing the user during presentation. This information can be obtained from login data, for example, and/or from other sources of personal information stored on the client machine.

These are only a few examples of information and user behavior and interaction data that can be learned and reasoned, and should not be construed as limiting in any way.

As a brief, but not all inclusive summary, novel aspects described herein relate to information privacy, performing analytics, model building, prediction and matching on the client-side by downloading/caching spanning content for advertising that provides enough fodder so as to do locally, personalized and context-sensitive matching based on analysis (locally and privately) of a user's content (documents) and behavior (e.g. application usage, searching, locations, patterns of locations with GPS), and even derived demographics (e.g., look in particular locations and at behaviors to infer a probability distribution over age, gender, . . . ).

It is within contemplation of the disclosed architecture that a large quantity of advertisements can be transmitted down to the client where local matching is performed for selecting advertisements to present based on local behavior and local content. For example, this can include examination of a large scale crawl of the local hard drive, and behaviors (e.g., searches, URLs visited, and GPS locations for a mobile system). Privacy can be maintained related to the details of the matching process, etc., since context or interactions outside of the client are not transmitted—all matching occurs internally. Additionally, clickthroughs on ads can be monitored, and these can be used to regenerate new large scale downloads to the client, which are even better optimized. The clickthroughs can also be used locally in decision making.

Experiments can be conducted with subjects who offer to share personal data, as volunteers or in return for reimbursements, that allow learning more about the details of the relationship between local content, behaviors, etc., and this knowledge can be used to do better privacy-maintaining analyses for others.

On the commodity side, advertisements can be sold based on numbers of impressions promised on the client, notions of when the ads are shown on a client, based on local content, that is not confirmed, but expected via studies with volunteers (for privacy purposes), based on local content, where numbers of impressions are monitored (where privacy is not important), etc. Alternatively, a volunteer approach can be employed for selling and pricing ads, perhaps along with enticements to participate, where the privacy described belongs to the volunteers, only, and not all people.

Additionally, estimates can be abstracted based on knowing what the volunteers do, and knowing some basic signal, for example, a signal about how many systems are out there and are being actively used Oust sending back a “usage signal”-not anything on details of privacy). Accordingly, privacy can be maintained by just sending back a high-level “usage” signal or “active” signal. Alternatively, or in combination therewith, noting a download of the system or cached content can be monitored and utilized.

Learning and reasoning algorithm facilitate making good decisions as to when to show advertisements, given models of attention. For example, downloads can be made to a mobile device such as a PDA or automobile, during tethered or even mobile times. Advertisements can then be cached and then rendered at the right time (e.g., for a car, when the car stops).

In another example, advertisements can be processed for download and presentation when learning and reasoning indicates that advertisements would be minimally disruptive, (e.g., after completion of tasks such as sending an e-mail, closing an application, . . . ), before transitioning to new tasks, etc.

Additionally, audio and/or visual advertisements can be rendered at times in the rendering of content within a radio broadcast or podcast, when a commercial would fit (e.g., between songs, after a news story, after a radio announcer or TV announcer utters key trigger words and/or phrases such as, “And now for a commercial break.”

In still other implementations, mechanisms and business models can be employed that allow cached and relevant local advertisement content be rendered as one or more slots of a commercial break. Consider the following example scenario. A user is noted to be commuting home along a route that has become recognized via watching GPS of a user's routes and destinations over time. Advertisements are cached ahead of time, and are revealed and rendered based on the details of the user context based on, for example, the route traveled, road conditions, the user's velocity and the time of day, and day of the week. Moreover, personalized advertisements can be queued up (or cached or prefetched) to be shown within some predetermined timeframe, but the exact timing can be based on other factors such as the start of a slot, deemed as a commercial spot in a broadcast.

A broadcast company may send a signal that a local, personalized ad from a cache can now run, in lieu of a generic advertisement being broadcast to all. In one approach, the advertisements are cached down in a side-channel of the broadcaster's main frequencies enabling advertising slots in broadcasts to be personalized to the user via many different types of intelligent appliances, based on the local context or usage.

The same can be done with television ads, where ads are cached locally in a personal digital assistance, a desktop computer, or PVR (personal video recorder), for example, and render the ads at the right times, per ad slots, etc., based on knowledge gleaned about the users, even if, per privacy, all of the details about the behaviors and content that is being tracked is kept local and private. This provides means for ensuring relative privacy while traveling to town, for example, on processing details that enable matching, per behaviors, locations, etc.

Revenue sharing can be applied where one company provides the cached ads and uses the broadcast or surrounding content as a host for the ad, when the slot comes up.

In another example, mechanisms can be put into place that allow some backchannel, for example, it is known what is purchased or clicked on, now seek to know one or more attributes (or properties) about the user, and ask for permission to send these attributes back.

Local processing can be implemented, where the age, location, and other demographics of the user are identified so as to help with targeting internally, without sharing such information outside of the client. As an example, impressions can be sold to an advertiser that provide custom-tailored advertisements for different age groups (spanning a comprehensive range of ages) and then the right age-centric advertisements rendered, per the local inferences, even if this private information is never shared to outside sources.

In another approach, by agreement, privacy is not a consideration, and therefore, inferences about demographics can be computed from the content and behavior of users, and this information is used in designing policies for caching advertising content, for selling impressions to advertisers, and for deciding about if, how, and when to render.

By applying learning and reasoning, optimizations can be computed associated with the if, when, what, and how to show advertisements all locally for particular users, but also doing tests and watching responses to advertisements. Learning can also be obtained from people who have given permission to do so, and then apply the methods internally, on the client side for people who have not given permission, so as to get maximum return on advertisements, but while maintaining analysis on the client side, so as to maintain privacy on content and behavior.

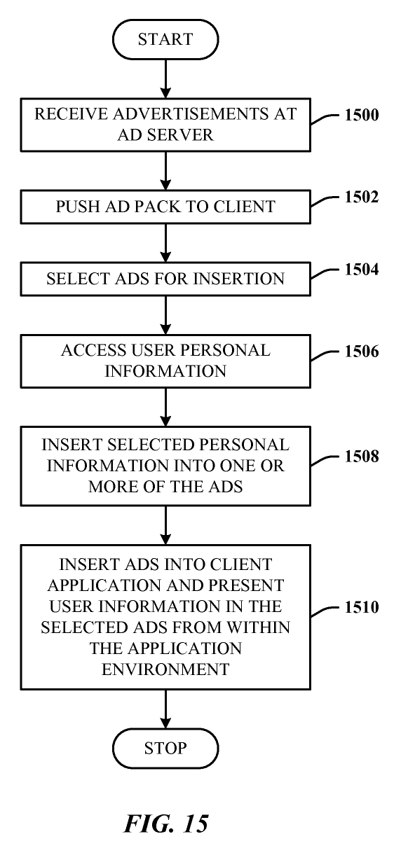

FIG. 15 illustrates a methodology of inserting person information into an advertisement for presentation within a client application environment. At 1500, advertisements are received at an ad server. At 1502, an ad pack is assembled at the ad server and pushed down to the client machine. At 1504, one or more ads of the ad pack are selected for insertion processing. At 1506, user personal information is accessed on the client machine. At 1508, selected personal information is inserted into one or more of the ads. At 1510, the ads selected for insertion are inserted into the client application and the user information presented in one or more of the ads from within the application environment.

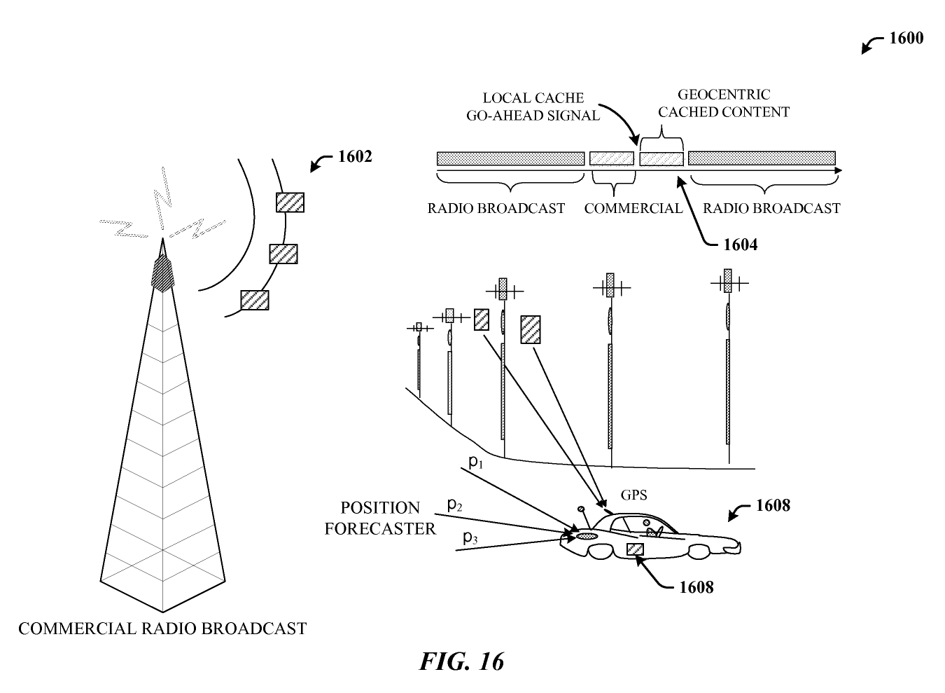

FIG. 16 illustrates an example of a system 1600 for geocentric caching and rendering of content. A commercial radio company may wish to send (e.g. broadcast) personalized, geocentric, content 1602 that is cached and made available to the user at the appropriate locations, times during specially signaled, timed slots, etc. Such information can be sent on an alternate channel. Alternatively, a broadcaster may opt to sell slots to third parties that transmit and manage such geocentric caching systems 1600 that transmit and render such customized, location-specific information, at appropriate timing slots in an ongoing commercial broadcast. In the latter approach, participating commercial radio stations sell standard commercial slots 1604 for the rendering of content that has been previously cached in a cache 1606 by a proactive caching system that considers the size of content components, the location of a user's vehicle 1608 and the velocity and likely path of the vehicle. When a go-ahead signal is received from the broadcaster for the rendering of an n second piece of cached content that represents position-relevant directed advertising, cached content is played. After the cached content is rendered, the system is returned to the commercial broadcast.

Following is a more detailed description of a mechanism for considering a user's previous preferences and behavior (e.g., purchase activity) coupled with the use of forecasts of future locations in a mobile setting (based on patterns of travel over time or current real-time direction and velocity) to identify information and advertising content that may have the most value to users or be the most effective advertising content for selling products and services.

Information can be combined about the time of day, the current location and/or forecasts about the near-term, future location of the user with methods for predicting the impact of an advertisement on a user (e.g., see directed advertising work for MSNBC), for example, given an analysis of similar users, or preferences of the user to see information. Methods for identifying a user's informational preferences include the use of probabilistic and rule-based user models, including statistical models that perform “collaborative filtering” which leverages statistics collected about the behavior or preferences of many users over time to generate an assessment of preferences of a particular user, based on a consideration of partial information about the preferences of that user.

By coupling other parameters such as position, velocity, and likely path information with preference information, this drives the caching and rendering of personalized directed advertising or notifications. Multiple distinct pieces of content (e.g., distinct advertisements) can be cached in a sequence based on an ordering over the assessed or inferred time-criticality of the content, given the inferred preferences, as well as the location and velocity of users, or, via a cost-benefit consideration of the expected value of alternate sequences of the pieces of content, given the preferences, location, and velocity of users. One approximation is to cache the content by the cost of delay divided by the size of the content.

Decisions about the timing and the rendering of the information can be made based on a cost-benefit analysis, and with consideration to location—and in many cases, of the nature and structure of other content that may have already been streaming (e.g., music being listened to for purposes of entertainment).

The method enables the ongoing caching of potentially personalized and location-centric information coupled with methods for decision making about the best time and number of times to render the information to users.

Settings can include the caching and rendering of advertising audio and/or graphics content in automobile-based devices. In one application, commercial breaks in local or broadcast music entertainment are detected and filled with appropriately timed commercial content that has been cached. In other cases, a cost-benefit analysis, based on client-side decision making or on cached attributes that indicate the cost of deferring the rendering of the information can be used to preempt entertainment.

As an example, consider the case of rendering cached audio content in a setting where a user is listening to an ongoing stream of audio as part of news or music. The expected value of rendering cached information now versus later may outweigh the cost of an interruption of listening to the current audio stream. In such cases, elegant transitions in volume can be coupled, and potentially make use of transitional remarks, in going to and from the cached content, returning to the audio in progress. Application extensions include the storage or halting of the rendition of the initial stream so as to minimize loss of content when the cached notification or message is displayed. Other opportunities for rendering information and advertising content include intervals following the completion of specific titles rendered locally (e.g., CD player), or during delays for CD switching or for the downloading of new desired digital entertainment from a potentially intermittent or low-bandwidth network.

The method can be coupled with several business models where the caching and rendering of previously cached directed advertising information is purchased by advertisers, and where listeners who are provided with content, are also provided with the advertisements.

Overlaying notifications and advertising can be keyed to a background audio stream that is created from server or client-based digital entertainment and information content. The cached information and advertising content can also be used to simply detect and overlay existing commercials in broadcasted audio or video.

Alternatively, in a business model akin to the sales of local commercial spots by radio and television networks, special signals can be provided by content providers (such as broadcasters) to give the go ahead for the rendering of cached content that is timed to fit within a particular commercial slot. Such models would allow audio and visual content providers to sell such local, cached commercial spots containing geocentric, personalized information, or to manage such local directed advertising themselves. FIG. 16 captures one implementation of an overall geocentric caching scheme and associated business model.

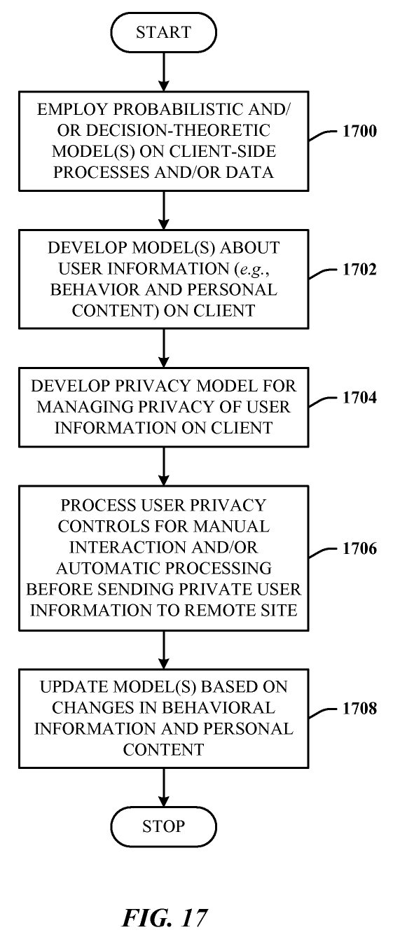

FIG. 17 illustrates a methodology of managing client-side information based on privacy. At 1700, probabilistic and/or decision-theoretic model(s) can be employed to develop probability data and, learn and reason about client-side user and/or system processes. At 1702, model(s) are developed about the user information that can include at least behavioral information and personal content of the client. At 1704, a privacy model is developed for managing privacy related to behavioral and personal content, as well as information that can be derived indirectly through user interaction with content (e.g. clickthrough rates) and context information, for example. At 1706, the model is processed to effect user privacy controls for manual interaction and/or automatic processing before sending private user information from the client to a remote site. At 1708, the model is updated to reflect changes in user behavioral information and personal content interaction, for example.

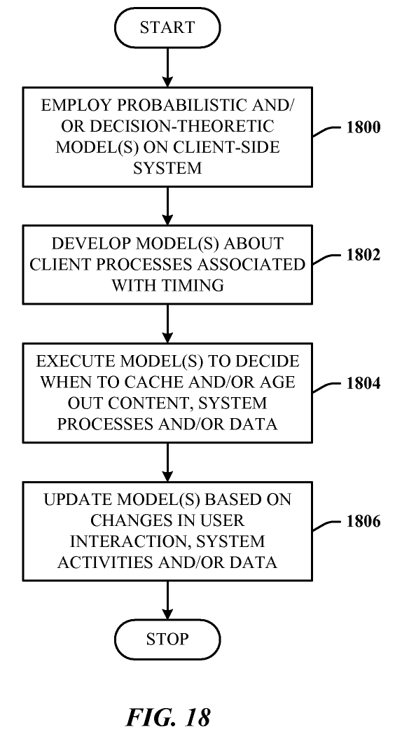

FIG. 18 illustrates a methodology of managing client-side information related to the timing of processes. At 1800, probabilistic and/or decision-theoretic model(s) can be employed to develop probability data and, learn and reason about client-side user activities, behavior and/or system processes. At 1802, model(s) are developed about client-side processes associated with timing. At 1804, a model(s) are developed to decide when to cache and/or age-out content, system processes and/or data. At 1806, the model is updated to reflect changes in user interaction, system activities and/or data, for example.

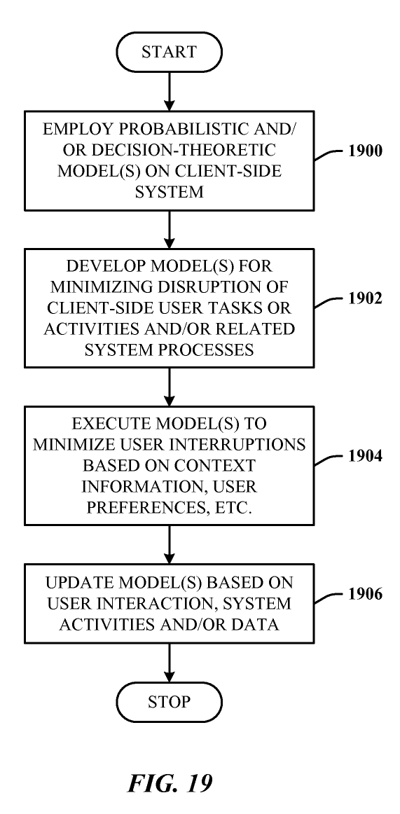

FIG. 19 illustrates a methodology of managing client-side disruptions of user and/or client processes. At 1900, probabilistic and/or decision-theoretic model(s) can be employed to develop probability data and, learn and reason about client-side user activities, behavior and/or system processes. At 1902, model(s) are developed for learning and reasoning about disruptions, for example, client-side user tasks or activities and/or related system processes. At 1904, the model(s) are executed to minimize user interruptions based on context information, user preferences, system resources, etc. At 1906, the model(s) are updated to reflect changes in user interaction, system activities and/or data, for example.

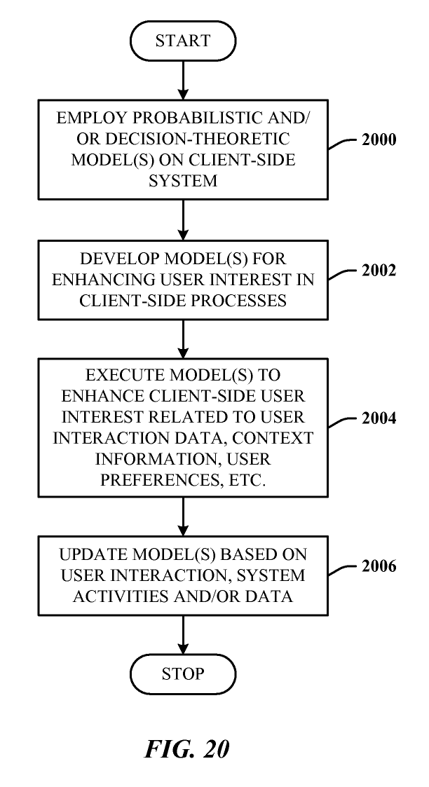

FIG. 20 illustrates a methodology of enhancing user interest in client-side processes or information. At 2000, probabilistic and/or decision-theoretic model(s) can be employed to develop probability data and, learn and reason about client-side user activities, behavior and/or system processes. At 2002, model(s) are developed for learning and reasoning about user interest in client-side processes, programs and/or data. At 2004, the model(s) are processed to enhance user interest related to user interaction data, context information, user preferences, advertising information(e.g., content, format, duration, . . . ). Enhancements can include combining music with presentation of the image content, muting the audio content during presentation of the content, jumping to other content when the content is presented, and so on. At 2006, the model(s) are updated to reflect changes in user interaction data, context information, user preferences, and advertising information, for example.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

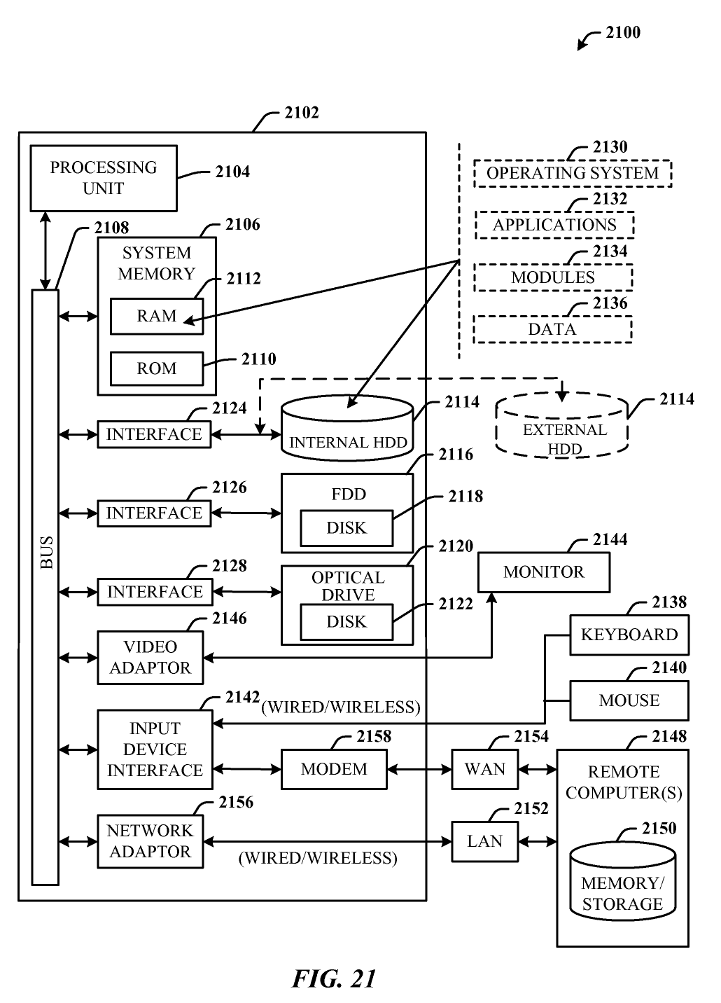

Referring now to FIG. 21, there is illustrated a block diagram of a computer operable to execute the disclosed client application advertisement processing and insertion architecture. In order to provide additional context for various aspects thereof, FIG. 21 and the following discussion are intended to provide a brief, general description of a suitable computing environment 2100 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 21, the exemplary environment 2100 for implementing various aspects includes a computer 2102, the computer 2102 including a processing unit 2104, a system memory 2106 and a system bus 2108. The system bus 2108 couples system components including, but not limited to, the system memory 2106 to the processing unit 2104. The processing unit 2104 can be any of various commercially available processors. Dual microprocessors and other multi-processor architectures may also be employed as the processing unit 2104.

The system bus 2108 can be any of several types of bus structure that may further interconnect to a memory bus (with or without a memory controller), a peripheral bus, and a local bus using any of a variety of commercially available bus architectures. The system memory 2106 includes read-only memory (ROM) 2110 and random access memory (RAM) 2112. A basic input/output system (BIOS) is stored in a non-volatile memory 2110 such as ROM, EPROM, EEPROM, which BIOS contains the basic routines that help to transfer information between elements within the computer 2102, such as during start-up. The RAM 2112 can also include a high-speed RAM such as static RAM for caching data.

The computer 2102 further includes an internal hard disk drive (HDD) 2114 (e.g., EIDE, SATA), which internal hard disk drive 2114 may also be configured for external use in a suitable chassis (not shown), a magnetic floppy disk drive (FDD) 2116, (e.g., to read from or write to a removable diskette 2118) and an optical disk drive 2120, (e.g., reading a CD-ROM disk 2122 or, to read from or write to other high capacity optical media such as the DVD). The hard disk drive 2114, magnetic disk drive 2116 and optical disk drive 2120 can be connected to the system bus 2108 by a hard disk drive interface 2124, a magnetic disk drive interface 2126 and an optical drive interface 2128, respectively. The interface 2124 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 2102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 2112, including an operating system 2130, one or more application programs 2132, other program modules 2134 and program data 2136. All or portions of the operating system, applications, modules, and/or data can also be cached in the RAM 2112. It is to be appreciated that the innovation can be implemented with various commercially available operating systems or combinations of operating systems.

A user can enter commands and information into the computer 2102 through one or more wired/wireless input devices, e.g. a keyboard 2138 and a pointing device, such as a mouse 2140. Other input devices (not shown) may include a microphone, an IR remote control, a joystick, a game pad, a stylus pen, touch screen, or the like. These and other input devices are often connected to the processing unit 2104 through an input device interface 2142 that is coupled to the system bus 2108, but can be connected by other interfaces, such as a parallel port, an IEEE 1394 serial port, a game port, a USB port, an IR interface, etc.

A monitor 2144 or other type of display device is also connected to the system bus 2108 via an interface, such as a video adapter 2146. In addition to the monitor 2144, a computer typically includes other peripheral output devices (not shown), such as speakers, printers, etc.

The computer 2102 may operate in a networked environment using logical connections via wired and/or wireless communications to one or more remote computers, such as a remote computer(s) 2148. The remote computer(s) 2148 can be a workstation, a server computer, a router, a personal computer, portable computer, microprocessor-based entertainment appliance, a peer device or other common network node, and typically includes many or all of the elements described relative to the computer 2102, although, for purposes of brevity, only a memory/storage device 2150 is illustrated. The logical connections depicted include wired/wireless connectivity to a local area network (LAN) 2152 and/or larger networks, e.g., a wide area network (WAN) 2154. Such LAN and WAN networking environments are commonplace in offices and companies, and facilitate enterprise-wide computer networks, such as intranets, all of which may connect to a global communications network, e.g., the Internet.

When used in a LAN networking environment, the computer 2102 is connected to the local network 2152 through a wired and/or wireless communication network interface or adapter 2156. The adaptor 2156 may facilitate wired or wireless communication to the LAN 2152, which may also include a wireless access point disposed thereon for communicating with the wireless adaptor 2156.

When used in a WAN networking environment, the computer 2102 can include a modem 2158, or is connected to a communications server on the WAN 2154, or has other means for establishing communications over the WAN 2154, such as by way of the Internet. The modem 2158, which can be internal or external and a wired or wireless device, is connected to the system bus 2108 via the serial port interface 2142. In a networked environment, program modules depicted relative to the computer 2102, or portions thereof, can be stored in the remote memory/storage device 2150. It will be appreciated that the network connections shown are exemplary and other means of establishing a communications link between the computers can be used.

The computer 2102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g. a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10 BaseT wired Ethernet networks used in many offices.

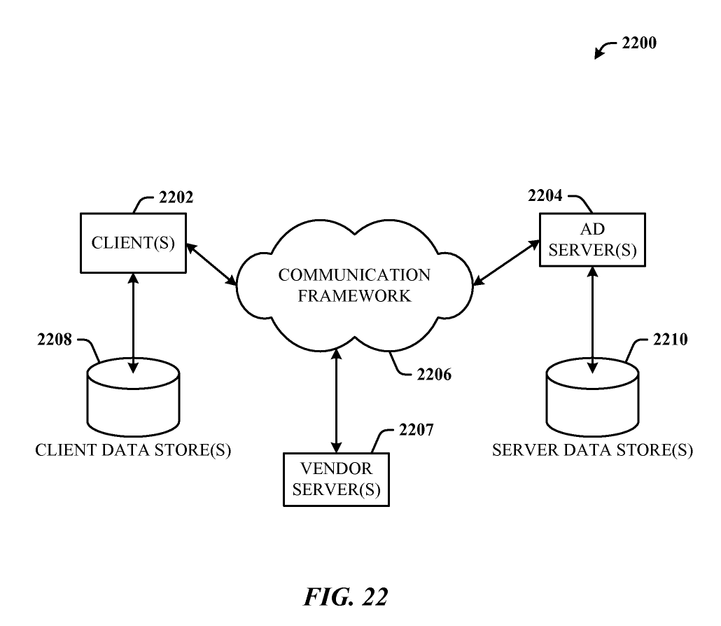

Referring now to FIG. 22, there is illustrated a schematic block diagram of an exemplary client application advertisement processing and insertion computing environment 2200 in accordance with another aspect. The system 2200 includes one or more client(s) 2202 to which ad packs can be pushed. The client(s) 2202 can be hardware and/or software (e.g. threads, processes, computing devices). The client(s) 2202 can house cookie(s) and/or associated contextual information by employing the subject innovation, for example.

The system 2200 also includes one or more server(s) 2204. The servers 2204 can include ad servers to which vendors of vendor servers 2207 send ads for download to client applications. The server(s) 2204 can also be hardware and/or software (e.g., threads, processes, computing devices). The servers 2204 can house threads to perform transformations by employing the invention, for example. One possible communication between a client 2202 and a server 2204 can be in the form of a data packet adapted to be transmitted between two or more computer processes. The data packet may include a cookie and/or associated contextual information, for example. The system 2200 includes a communication framework 2206 (e.g. a global communication network such as the Internet) that can be employed to facilitate communications between the client(s) 2202 and the server(s) 2204.

Communications can be facilitated via a wired (including optical fiber) and/or wireless technology. The client(s) 2202 are operatively connected to one or more client data store(s) 2208 that can be employed to store information local to the client(s) 2202 (e.g., cookie(s) and/or associated contextual information). Similarly, the server(s) 2204 are operatively connected to one or more server data store(s) 2210 that can be employed to store information local to the servers 2204.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates client-side advertising in a client, the client comprising:
an advertisement component for receiving and processing advertisement content;
an application component for inserting the advertisement content into a client application for presentation to a user; and
a probabilistic learning and reasoning component for generating a model that applies a learning and reasoning process to client processes of the advertisement component and the application component.

2. The system of claim 1, wherein the application component facilitates client-side analysis that includes sensitive user and client information, and which sensitive user and client information is prohibited from being communicated externally from the client.

3. The system of claim 1, further comprising a context component that senses, collects and stores context information related to the client's geographic location and patterns of locations, and which facilitates insertion of the advertisement content at an appropriate time.

4. The system of claim 1, wherein the advertisement content inserted into the application by the application component is targeted to the user.

5. The system of claim 1, wherein the application component facilitates insertion of targeted advertising content into the client application that receives streaming content, the targeted advertising content timed for presentation during a commercial break of the streaming content.

6. The system of claim 1, wherein the application component facilitates external communication of client-side user and/or system information only after user confirmation that allows the communication.

7. The system of claim 1, wherein the probabilistic learning and reasoning component generates an enhancement model for processing information that enhances user interest in the advertisement content.

8. The system of claim 1, wherein the probabilistic learning and reasoning component generates an enhancement model for continually updating client-side advertisement content based on user privacy data.

9. The system of claim 1, wherein the probabilistic learning and reasoning component generates a timing model for processing and presenting the advertisement content into the client application at appropriate times.

10. The system of claim 1, wherein the probabilistic learning and reasoning component generates a timing model for managing caching operations of the advertisement content in the client.

11. The system of claim 10, wherein the timing model facilitates execution of client processes so as to minimize user disruption.

12. The system of claim 10, wherein the timing model facilitates execution of client processes so as to minimize client system disruption.

13. The system of claim 1, wherein the probabilistic learning and reasoning component generates a frustration model for analyzing and processing client-side data related to user frustration behavior.

14. A computer-implemented method of managing client-side content processing and presentation, comprising:
receiving advertisement content at a client from a vendor site for presentation in a client application;
monitoring user and system activity data in response to presentation of the advertisement content in a launched client application;
developing a probabilistic model locally based on the user and system activity data; and
processing the model to effect user behavior and system processes.

15. The method of claim 14, further comprising modeling context information in the probabilistic model related to geographic location of the client.

16. The method of claim 14, further comprising pushing the advertisement content to subjects who share out personal data and activities to measure and model relationships between content, activities, interests, and behavioral responses, such as showing signs of disinterest or signs of interest such as dwells and clickthroughs on advertisements so as to better understand the expected behaviors of users who do not share private information.

17. The method of claim 14, further comprising modeling disruption data associated with disrupting user activity by monitoring user task completion and application transitioning.

18. The method of claim 14, further comprising updating the advertisement content in the client application based on a change in geographic location of the client.

19. The method of claim 14, further comprising updating cache content based on a change in geographic location of the client.

20. A computer-executable system for inserting advertisements in a client application, comprising:
computer-implemented means for receiving and processing advertisement data for insertion into a client application;
computer-implemented means for selecting the advertisement data based on at least one of user state and user preferences;
computer-implemented means for personalizing the advertisement data;
computer-implemented means for inserting the advertisement data into the client application for presentation to a client user; and
computer-implemented means for probabilistically modeling user and system behavior based on perception of the personalized advertisement data by the client user in the client application.
